(19) United States
(12) Patent Application Publication
(10) Pub. No.: US 2026/0001337 A1
(43) Pub. Date: Jan. 1, 2026

(54) Liquid Ejecting Head And Liquid Ejecting Apparatus

(71) Applicant: SEIKO EPSON CORPORATION, Tokyo (JP)

(72) Inventors: Hiroyuki HAGIWARA, Matsumoto (JP); Shun KATSUIE, Matsumoto (JP)

(21) Appl. No.: 19/248,722

(22) Filed: Jun. 25, 2025

(30) Foreign Application Priority Data
Jun. 26, 2024 (JP) 2024-103081

(51) Int. Cl. B41J 2/175; B41J 2/14

(52) U.S. Cl. CPC B41J 2/17523; B41J 2/14; B41J 2002/14362; B41J 2002/14491

(57) ABSTRACT

A liquid ejecting head includes a liquid ejecting unit, a flow path member in communication with the liquid ejecting unit, a relay substrate electrically connected to the liquid ejecting unit, and a cover that accommodates at least one of the flow path member and the relay substrate therein and is configured expand and contract in a height direction.

The present application is based on, and claims priority from JP Application Serial Number 2024-103081, filed Jun. 26, 2024, the disclosure of which is hereby incorporated by reference herein in its entirety.

### BACKGROUND

### 1. Technical Field

The present disclosure relates to a liquid ejecting head and a liquid ejecting apparatus that eject a liquid from nozzles and particularly to an ink jet recording head and an ink jet recording apparatus that eject ink as a liquid.

### 2. Related Art

A liquid ejecting apparatus represented by an ink jet recording apparatus such as an ink jet printer or a plotter includes a liquid ejecting head capable of ejecting a liquid such as ink stored in a cartridge, a tank, or the like. Such a liquid ejecting head includes a liquid ejecting unit that ejects a liquid, a base member that accommodates the liquid ejecting unit, a flow path member in communication with the liquid ejecting unit, a relay substrate electrically connected to the liquid ejecting unit, and a cover that accommodates the flow path member and the relay substrate therein between the cover and the base member (for example, refer to JP-A-2023-92733).

However, in a case where the height of the cover necessary for accommodating the components therein is different due to a change in the heights of the components accommodated inside the cover, a change in the number of accommodated components, a change in the arrangement of the components accommodated inside, or the like according to the specification of the liquid ejecting head, it is necessary to prepare different covers in accordance with the respective specifications. As a result, there are problems in which the management of the cover becomes complicated, the cost increases, and the environmental load increases.

### SUMMARY

According to an aspect of the present disclosure, there is provided a liquid ejecting head including a liquid ejecting unit that ejects a liquid, a flow path member in communication with the liquid ejecting unit, a relay substrate electrically connected to the liquid ejecting unit, and a cover that accommodates at least one of the flow path member and the relay substrate therein and is expandable and contractible in a height direction.

According to another aspect of the present disclosure, there is provided a liquid ejecting apparatus including the liquid ejecting head according to the above-described aspect, and a liquid storage unit that stores a liquid to be supplied to the liquid ejecting head.

### BRIEF DESCRIPTION OF THE DRAWINGS

FIG. 1 is a schematic configuration diagram of a liquid ejecting apparatus according to a first embodiment.

FIG. 2 is an exploded perspective view of a liquid ejecting head according to the first embodiment.

FIG. 3 is a plan view of the liquid ejecting head according to the first embodiment.

FIG. 4 is a sectional view of the liquid ejecting head according to the first embodiment.

FIG. 5 is a sectional view of the liquid ejecting head according to the first embodiment.

FIG. 6 is an enlarged sectional view of a main portion of the liquid ejecting head according to the first embodiment.

FIG. 7 is an enlarged sectional view of a main portion of the liquid ejecting head according to the first embodiment.

FIG. 8 is an enlarged sectional view of a main portion of the liquid ejecting head according to the first embodiment.

FIG. 9 is an enlarged sectional view of a main portion of a liquid ejecting head according to a second embodiment.

FIG. 10 is an enlarged sectional view of a main portion of the liquid ejecting head according to the second embodiment.

FIG. 11 is an enlarged sectional view of a main portion of a liquid ejecting head according to a third embodiment.

FIG. 12 is an enlarged sectional view of a main portion of the liquid ejecting head according to the third embodiment.

FIG. 13 is an enlarged sectional view of a main portion of a modification of the liquid ejecting head according to the third embodiment.

FIG. 14 is an enlarged sectional view of a main portion of the modification of the liquid ejecting head according to the third embodiment.

FIG. 15 is an enlarged sectional view of a main portion of the modification of the liquid ejecting head according to the third embodiment.

FIG. 16 is an enlarged sectional view of a main portion of a liquid ejecting head according to another embodiment.

FIG. 17 is an enlarged sectional view of a main portion of the liquid ejecting head according to another embodiment.

### DESCRIPTION OF EMBODIMENTS

The present disclosure will be described in detail below based on embodiments. However, the following description illustrates an aspect of the present disclosure and can be appropriately changed within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, a +Z direction indicates a vertically downward direction, and a −Z direction indicates a vertically upward direction. The −Z direction is an example of a “height direction”. In addition, the directions of three spatial axes that do not limit the positive direction and the negative direction will be described as an X-axis direction, a Y-axis direction, and a Z-axis direction.

### First Embodiment

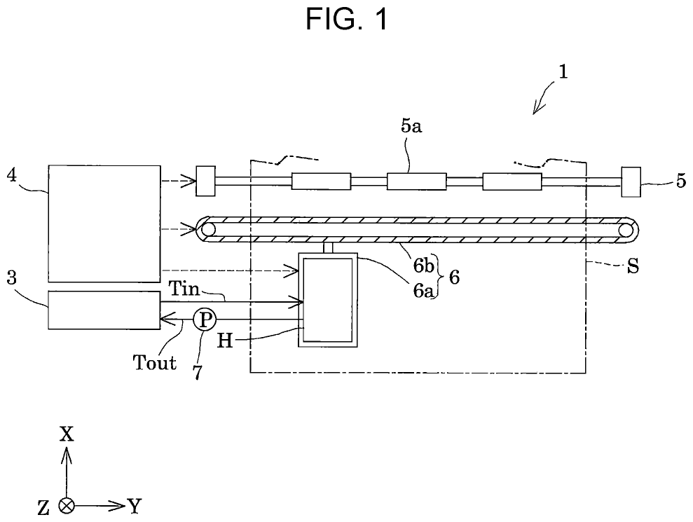

FIG. 1 is a diagram illustrating a schematic configuration of a liquid ejecting apparatus 1 according to the present disclosure.

As illustrated in the drawing, the liquid ejecting apparatus 1 is a so-called serial printer that includes a liquid ejecting head H and performs printing by ejecting, which is also referred to as discharging, a liquid from the liquid ejecting head H toward a medium S in the +Z direction while transporting the medium S in the X-axis direction and reciprocating the liquid ejecting head H in the Y-axis direction. As the medium S, in addition to recording paper, any material such as a resin film or cloth can be used.

The liquid ejecting apparatus 1 includes the liquid ejecting head H, a liquid storage unit 3, a control unit 4, a transport mechanism 5 that sends the medium S, and a moving mechanism 6.

The liquid ejecting head H ejects a liquid to be supplied from the liquid storage unit 3 as droplets in the +Z direction.

The liquid storage unit 3 individually stores a plurality of types of ink having different colors and components ejected from the liquid ejecting head H. Examples of the liquid storage unit 3 include a cartridge attachable to and detachable from the liquid ejecting apparatus 1, a bag-shaped ink pack made of a flexible film, and an ink tank that can be refilled with ink. FIG. 1 illustrates one liquid storage unit 3. Incidentally, the liquid storage unit 3 may be a liquid storage unit 3 including divided chambers for individually storing a plurality of types of ink or may be a plurality of liquid storage units 3 individually provided according to the plurality of types of ink. In addition, the liquid storage unit 3 may be divided into a main tank and a sub-tank. A configuration may be adopted in which the sub-tank is connected to the liquid ejecting head H, and the ink consumed by ejecting the ink from the liquid ejecting head H is refilled from the main tank to the sub-tank.

A supply tube Tin and a discharge tube Tout are connected to the liquid storage unit 3. In FIG. 1, one supply tube Tin and one discharge tube Tout are illustrated as an example, but the supply tube Tin and the discharge tube Tout are provided for each of the different types of ink.

The supply tube Tin is a tube that supplies, to the liquid ejecting head H, the ink of the liquid storage unit 3 caused to have a predetermined pressure by a pump 7. The discharge tube Tout is a tube that collects the ink collected from the liquid ejecting head H to the liquid storage unit 3.

The control unit 4 includes, for example, a control device such as a central processing unit (CPU) or a field programmable gate array (FPGA), and a storage device such as a semiconductor memory. The control unit 4 also includes a power supply device that supplies power supplied from an external power supply such as a commercial power supply to each element of the liquid ejecting apparatus 1. The control unit 4 is electrically connected to the liquid ejecting head H via external wiring (not illustrated). The control unit 4 comprehensively controls each element of the liquid ejecting apparatus 1 by the control device executing a program stored in the storage device.

The transport mechanism 5 transports the medium S in the X-axis direction and includes, for example, a transport roller 5a rotated by a transport motor controlled and driven by the control unit 4.

The moving mechanism 6 is a mechanism for reciprocating the liquid ejecting head H in the Y-axis direction and includes a holding body 6a that holds the liquid ejecting head H and a transport belt 6b that is an endless belt installed in the Y-axis direction. The control unit 4 controls the driving of the transport motor (not illustrated) to rotate the transport belt 6b and reciprocate the liquid ejecting head H in the Y-axis direction together with the holding body 6a fixed to the transport belt 6b. The liquid storage unit 3 can also be mounted on the holding body 6a together with the liquid ejecting head H. The holding body 6a holds one liquid ejecting head H, but the holding body 6a may hold two or more liquid ejecting heads H.

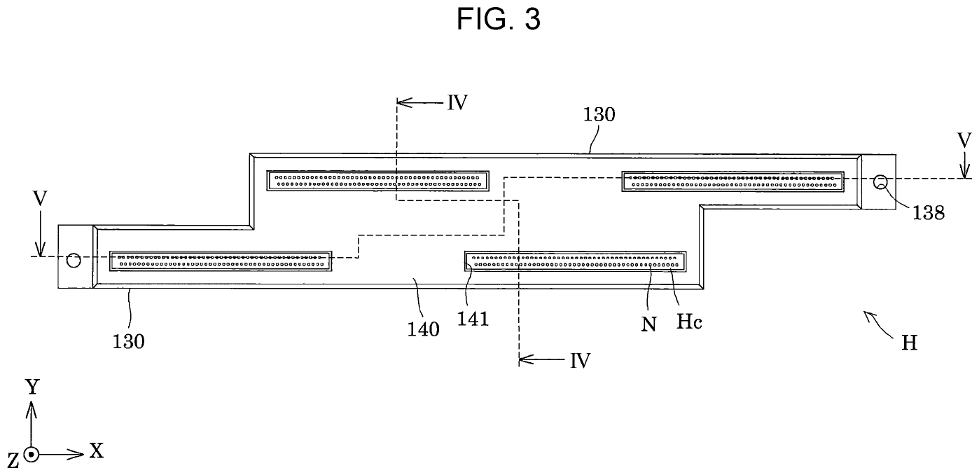

The liquid ejecting head H performs a discharge operation of discharging the ink supplied from the liquid storage unit 3 in the +Z direction as ink droplets from each of a plurality of nozzles N (refer to FIG. 3) under the control of the control unit 4. The control unit 4 functions as a discharge control unit that controls discharge of the ink by the liquid ejecting head H. The discharge operation by the liquid ejecting head H is performed in parallel with the transport of the medium S in the X-axis direction by the transport mechanism 5 and the reciprocating movement of the liquid ejecting head H in the Y-axis direction by the moving mechanism 6, whereby so-called printing, in which the ink is applied to the medium S, is performed.

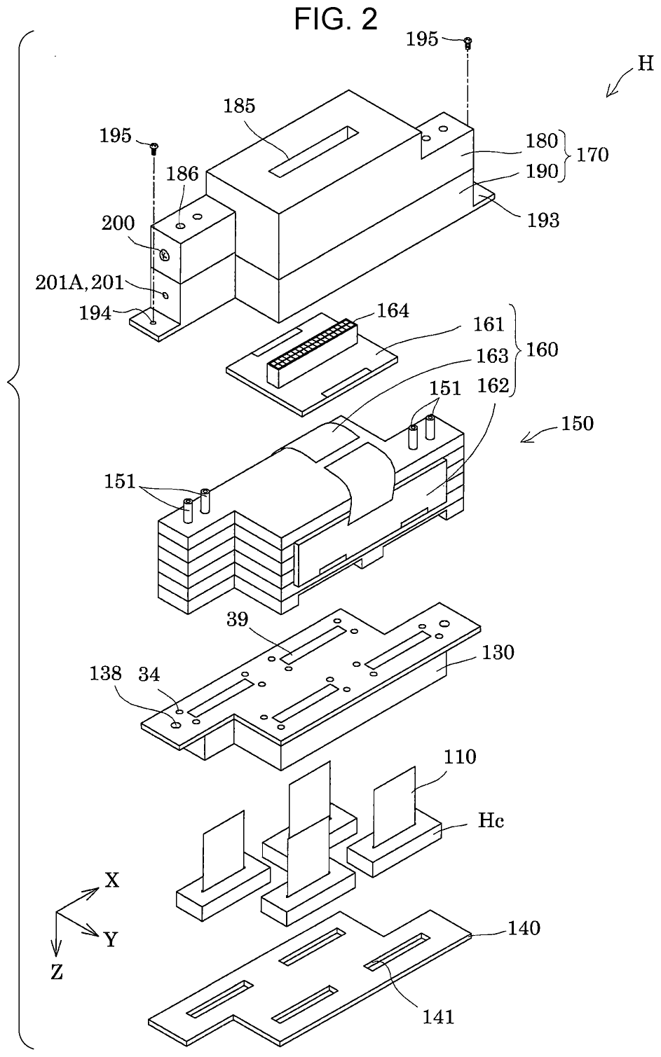

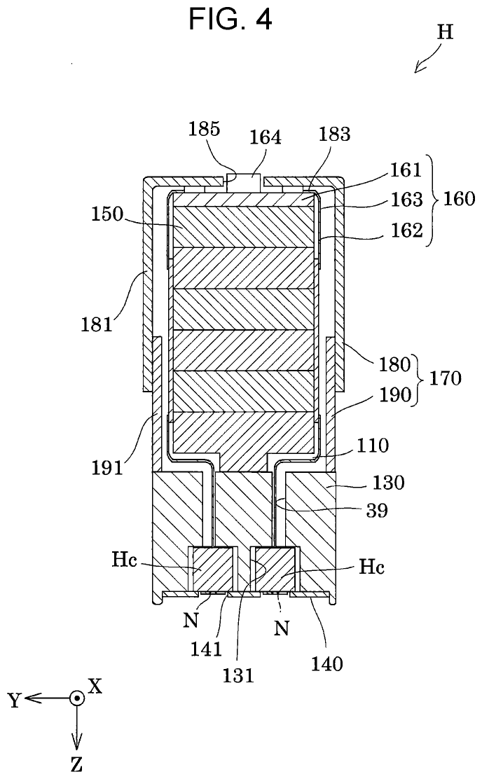

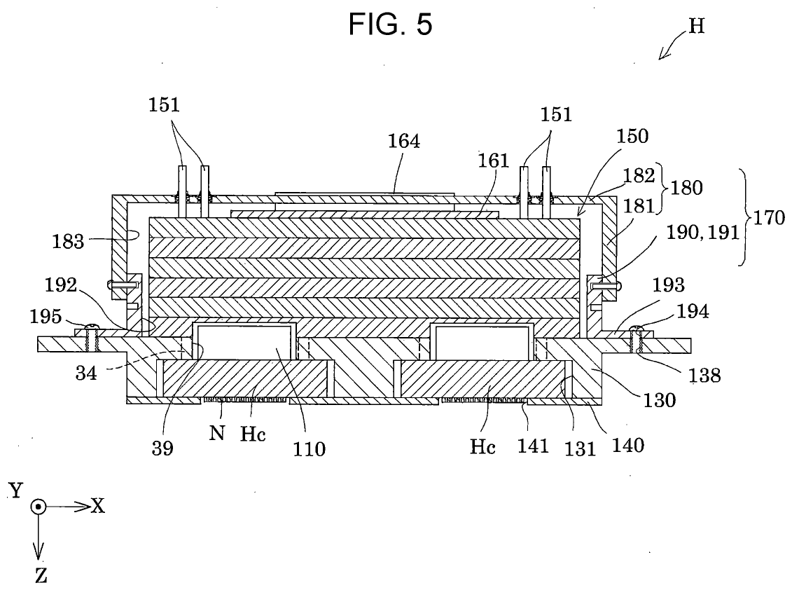

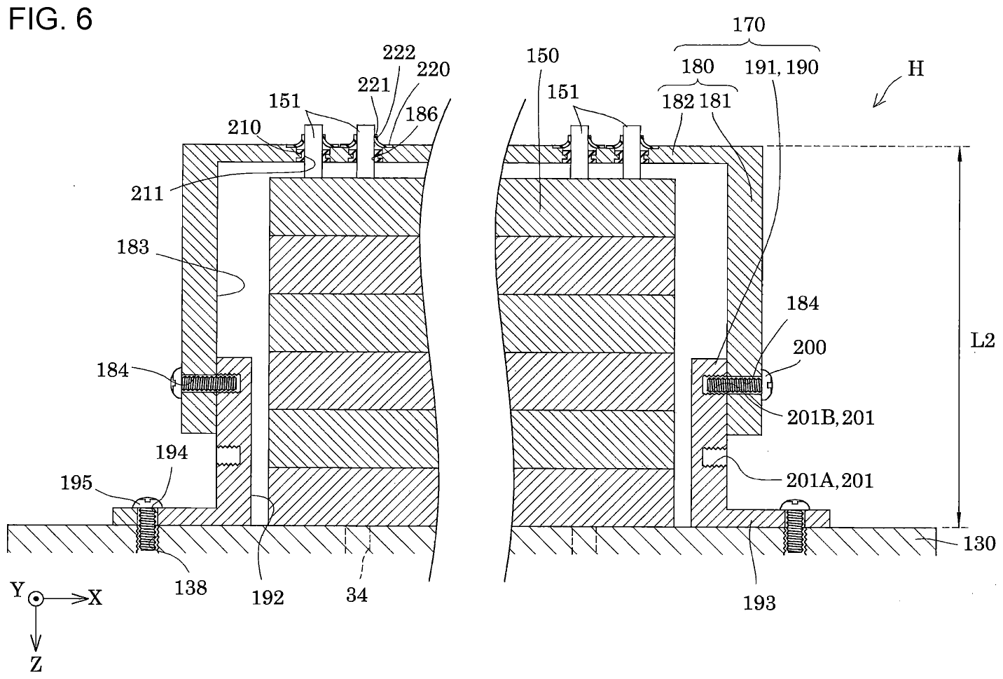

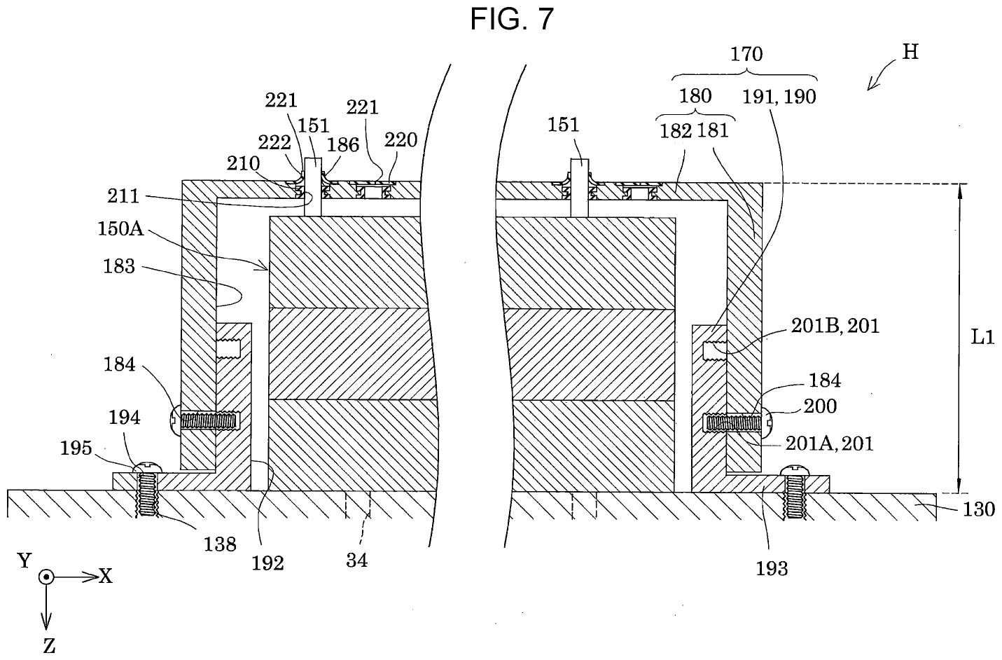

FIG. 2 is an exploded perspective view of the liquid ejecting head H according to a first embodiment. FIG. 3 is a plan view of the liquid ejecting head H when viewed in the −Z direction. FIG. 4 is a sectional view of a main portion taken along line IV-IV of FIG. 3. FIG. 5 is a sectional view of a main portion taken along line V-V of FIG. 3. FIG. 6 is an enlarged sectional view of a main portion of the liquid ejecting head H and is a view illustrating a second position. FIG. 7 is an enlarged sectional view of a main portion of the liquid ejecting head H and is a view illustrating a first position. Each direction of the liquid ejecting head H will be described based on the directions when the liquid ejecting head H is mounted in the liquid ejecting apparatus 1, that is, the X-axis direction, the Y-axis direction, and the Z-axis direction.

As illustrated in the drawing, the liquid ejecting head H includes a plurality of head chips Hc provided with the nozzles N that discharge ink droplets, a base member 130, a fixing plate 140, a flow path member 150, a relay substrate 160, and a cover 170.

Each head chip Hc is an example of a “liquid ejecting unit” and includes the plurality of nozzles N that ejects ink droplets as a liquid on the surface facing in the +Z direction that is opposite to the surface fixed to the base member 130. The plurality of nozzles N is arranged in a row in the X-axis direction to form a nozzle row. In the present embodiment, two nozzle rows are provided apart from each other in the Y-axis direction.

In the inside (not illustrated) of the head chip Hc, a flow path in communication with the nozzles N and a pressure generation unit that generates a pressure change in the ink in the flow path are provided. As the pressure generation unit, for example, it is possible to use a unit that causes a pressure change in the ink in the flow path by changing the volume of the flow path due to deformation of a piezoelectric actuator having a piezoelectric material that exhibits an electromechanical conversion function so as to causes ink droplets to be discharged from the nozzles N. In addition, as other pressure generation units, it is possible to use a unit in which a heating element is disposed in the flow path such that ink droplets are discharged from the nozzles N by bubbles generated by heating of the heating element, a so-called electrostatic actuator that causes an electrostatic force to be generated between a vibration plate and an electrode so that the vibration plate is deformed by the electrostatic force to discharge ink droplets from the nozzles N, or the like.

A wiring substrate 110 electrically connected to the pressure generation unit inside the head chip Hc is extended from the surface of the head chip Hc facing in the −Z direction. As the wiring substrate 110, a substrate having flexibility such as, for example, a chip on film (COF), a flexible flat cable (FFC), or a flexible printed circuit (FPC) is used.

The base member 130 includes an accommodation portion 131 having a recessed shape that opens to the surface facing in the +Z direction. In addition, the fixing plate 140 is fixed to the surface of the base member 130 facing in the +Z direction. The accommodation portion 131 of the base member 130 accommodates the plurality of head chips Hc fixed to the fixing plate 140. The opening of the accommodation portion 131 is partially sealed by the fixing plate 140. That is, each head chip Hc is accommodated in a space defined by the accommodation portion 131 and the fixing plate 140. The accommodation portion 131 may be provided for each head chip Hc or may be continuously provided over the plurality of head chips Hc. In the present embodiment, the accommodation portion 131 is provided for each head chip Hc.

In the base member 130 described above, the head chips Hc are arranged in zigzag in the X-axis direction. The number of the head chips Hc held by the base member 130 is not limited to four and may be one, or two or more.

The fixing plate 140 is formed of a plate-like member made of metal such as stainless steel. The fixing plate 140 includes an exposure opening 141 that exposes a nozzle surface on which the plurality of nozzles N of each head chip Hc is formed in the +Z direction. In the present embodiment, the exposure opening 141 is independently provided for each head chip Hc. The fixing plate 140 is fixed to the surface of the base member 130 facing in the +Z direction so as to close the opening of the accommodation portion 131.

In addition, the base member 130 includes a plurality of communication paths 34 through which ink flows between the head chip Hc and the flow path member 150. One end of each communication path 34 opens to the bottom surface of the accommodation portion 131, that is, the surface in the −Z direction in the accommodation portion 131 and in communication with the flow path of the head chip Hc. In the present embodiment, four communication paths 34 are provided for one head chip Hc. In addition, the other end of each communication path 34 opens to the surface of the base member 130 facing in the −Z direction and in communication with a flow path of the flow path member 150 which will be described in detail later. A supply path through which ink is supplied for each nozzle row and a discharge path through which ink not ejected from the nozzles N is discharged are provided inside the head chip Hc. Therefore, four flow paths in communication with the communication paths 34 of the head chip Hc are provided in total. Needless to say, the flow path may be branched in the head chip Hc. Therefore, the number of the communication paths 34 is not particularly limited thereto and may be one or two. The communication paths 34 do not have to be provided in the base member 130, and the flow path of the flow path member 150 and the flow path of the head chip Hc may be directly connected to each other.

In addition, a wiring insertion hole 39 through which the wiring substrate 110 of the head chip Hc is inserted is provided in the base member 130 for each accommodation portion 131. The wiring insertion hole 39 is provided to open to the bottom surface of the accommodation portion 131, that is, the surface on the −Z direction side in the accommodation portion 131 and to open to the surface on the −Z direction side of the base member 130.

The flow path member 150 is fixed to the surface of the base member 130 facing in the −Z direction. The flow path member 150 is constituted by a plurality of members stacked in the Z-axis direction, that is, six members in the present embodiment. A flow path that supplies ink to each head chip Hc and a flow path that discharges ink of each head chip Hc are provided inside the flow path member 150 (not illustrated). That is, the flow path member 150 is a member including flow paths in communication with the flow paths of the plurality of head chips Hc. In addition, four flow path connection portions 151 in communication with the flow paths inside the flow path member 150 are provided on the surface of the flow path member 150 facing in the −Z direction. Each flow path connection portion 151 is an example of a “flow path tube” and has a tubular shape protruding in the −Z direction. A tube can be connected to or removed from each flow path connection portion 151. So-called circulation is performed in which the ink from the liquid storage unit 3 is supplied from the flow path connection portion 151 through the supply tube Tin and the ink from the liquid ejecting head H is collected in the liquid storage unit 3 through the discharge tube Tout.

As illustrated in FIGS. 2 and 4, the relay substrate 160 includes a first relay substrate 161, a second relay substrate 162, and a third relay substrate 163 that connects the first relay substrate 161 and the second relay substrate 162.

The first relay substrate 161 is formed of a hard rigid substrate without flexibility, and wiring, an electronic component, and the like (not illustrated) are mounted thereon. In the present embodiment, as an example of the electronic component, an external connector 164 to which external wiring (not illustrated) provided outside the liquid ejecting head H is connected is illustrated. The first relay substrate 161 is fixed to the surface of the flow path member 150 facing in the −Z direction.

The second relay substrate 162 is formed of a hard rigid substrate without flexibility, and wiring, an electronic component, and the like (not illustrated) are mounted thereon. The wiring substrate 110 of the head chip Hc is connected to the second relay substrate 162.

The second relay substrate 162 is fixed to each of both side surfaces of the flow path member 150 in the Y-axis direction. That is, one liquid ejecting head H includes two second relay substrates 162. The wiring substrates 110 of the two head chips Hc located in the +Y direction are commonly connected to the second relay substrate 162 disposed in the +Y direction of the flow path member 150. In addition, the wiring substrates 110 of the two head chips Hc located in the −Y direction are commonly connected to the second relay substrate 162 disposed in the −Y direction of the flow path member 150.

The first relay substrate 161 and the two second relay substrates 162 are connected via the third relay substrates 163. Each third relay substrate 163 is formed of, for example, a flexible wiring substrate having flexibility.

A drive signal, a head control signal, and the like for controlling each head chip Hc are input from external wiring to the first relay substrate 161 via the external connector 164. The various signals input to the first relay substrate 161 are input to the two second relay substrates 162 via the third relay substrates 163 and are input to the head chips Hc from the second relay substrates 162. That is, the relay substrate 160 is a member to which the plurality of head chips Hc is electrically connected.

As illustrated in FIGS. 5 to 7, the cover 170 is fixed to the surface of the base member 130 facing the −Z direction and accommodates the flow path member 150 and the relay substrate 160 therein. The cover 170 described above protects the members accommodated therein, that is, the built-in components such as the flow path member 150 and the relay substrate 160 in the present embodiment from the external environment, for example, mist-like ink generated at the time of discharge, temperature such as high temperature or low temperature, high humidity, and the like to improve the gas barrier property, protects the built-in components from an impact from the outside, pressure at the time of gripping, and the like, and needs to be rigid in a degree to be durable to the external environment and the impact and stress from the outside. In the present embodiment, the cover 170 is mainly formed of resin, but may be partially or entirely formed of metal or the like. In addition, the cover 170 of the present embodiment accommodates both the flow path member 150 and the relay substrate 160 therein, but may accommodate at least one of the flow path member 150 and the relay substrate 160 therein.

The cover 170 can expand and contract in the Z-axis direction. Specifically, the cover 170 includes a first member 180 and a second member 190.

The first member 180 includes a first peripheral wall portion 181 having an annular shape when viewed in the Z-axis direction and a bottom wall portion 182 that closes an opening of the first peripheral wall portion 181 in the −Z direction. In the first member 180, a recessed portion 183 that opens to the surface facing in the +Z direction is defined by the first peripheral wall portion 181 and the bottom wall portion 182.

The second member 190 includes a second peripheral wall portion 191 having an annular shape when viewed in the Z-axis direction. In the second member 190, a first through portion 192, which is a through-hole extending in the Z-axis direction is defined by the second peripheral wall portion 191.

In addition, the second member 190 includes flange portions 193 that protrude in the +X direction and in the −X direction at end portions in the +Z direction. Each of the flange portions 193 is provided with a first cover fixing hole 194 passing through the flange portion 193 in the Z-axis direction, and in the second member 190, a cover fixing screw 195, which is a male screw, is inserted into the first cover fixing hole 194 of the flange portion 193 and is screwed into a second cover fixing hole 138 provided in the base member 130 and provided with a female screw, whereby the cover 170 is detachably fixed to the base member 130. The method of fixing the cover 170 to the base member 130 is not limited to fixing with screws and may be, for example, fixing performed by pinching the cover 170 and the base member 130 with a clamp or the like, fixing with an elastic force of a spring, or the like. However, since the cover 170 is fixed to the base member 130 by a fixing structure that can be easily attached to and detached from the base member 130, the cover 170 can be easily attached to and detached from the base member 130 when the specification of the liquid ejecting head H is changed, which will be described in detail later.

The recessed portion 183 of the first member 180 is slightly larger than the second peripheral wall portion 191 of the second member 190 when viewed in the Z-axis direction, and the second peripheral wall portion 191 of the second member 190 can be inserted into the recessed portion 183 of the first member 180. That is, the first member 180 is disposed outside the second member 190, and the second member 190 is disposed inside the first member 180. The relationship between “inside” and “outside” the first member 180 and the second member 190 refers to the positional relationship when the first peripheral wall portion 181 and the second peripheral wall portion 191 are viewed in the Z-axis direction. In this manner, in a state where the second peripheral wall portion 191 of the second member 190 is inserted into the recessed portion 183 of the first member 180, the first member 180 is movable in the Z-axis direction with respect to the second member 190. That is, the inner peripheral surface of the first peripheral wall portion 181 is guided by the outer peripheral surface of the second peripheral wall portion 191, whereby the first member 180 is movable in the Z-axis direction along the outer peripheral surface of the second peripheral wall portion 191 of the second member 190. By adjusting the position of the first member 180 in the Z-axis direction with respect to the second member 190, the cover 170 can expand and contract in the Z-axis direction. In the present embodiment, the position of the first member 180 in the Z-axis direction with respect to the second member 190 is movable between the first position illustrated in FIG. 7 and the second position illustrated in FIG. 6. The position of the first member 180 in the Z-axis direction with respect to the second member 190 at the second position is located in the −Z direction with respect to the position of the first member 180 in the Z-axis direction with respect to the second member 190 at the first position. That is, a dimension L2 in the Z-axis direction of the cover 170 at the second position is larger than a dimension L1 in the Z-axis direction of the cover 170 at the first position. That is, a relationship of L2>L1 is satisfied. Incidentally, the above-described flow path member 150 is accommodated in the cover 170 at the second position. On the other hand, at the first position, a flow path member 150A different from the flow path member 150 described above is accommodated in the cover 170. Here, the flow path member 150 and the flow path member 150A being different means that, for example, the number of stacked layers in the Z-axis direction, the number of components, and the like are different between the flow path members 150 and 150A. In the present embodiment, the flow path member 150 includes six members stacked in the Z-axis direction, and the flow path member 150A includes three members stacked in the Z-axis direction. Incidentally, the flow path member 150 and the flow path member 150A are different in the number of flow paths therein and the number of flow path connection portions 151. For example, in the flow path member 150A, one flow path connection portion 151 is provided at each of both end portions in the X-axis direction, that is, two flow path connection portions 151 in total are provided. As a factor for changing the height in the Z-axis direction of the built-in components accommodated in the cover 170, a factor other than the number of stacked layers of the members constituting the flow path member 150 is also considered. As another factor, for example, there is a case where the thickness of each member is different even when the number of stacked layers of the members constituting the flow path member 150 is the same. In addition, as still another factor, for example, there is a case where the dimension of the first relay substrate 161 in the Z-axis direction is different depending on the number of stacked layers of the first relay substrate 161 in the Z-axis direction accommodated inside the cover 170 other than the flow path member 150 or the arrangement of the first relay substrate 161, for example, whether a mounting surface of the electronic component of the first relay substrate 161 is arranged along the XY plane defined by the X-axis and the Y-axis as in the present embodiment or the mounting surface is arranged in the Z-axis direction. In addition, as another factor, a member other than the flow path member 150 and the relay substrate 160, for example, an intermediate member such as a member having a pressure regulating valve that opens when a flow path downstream has a negative pressure, a member including a filter that captures foreign substances such as bubbles contained in ink, or a member provided with a heater that heats the ink in a flow path is further provided between the flow path member 150 and the base member 130 in the cover 170. It is necessary to expand and contract the dimension of the cover 170 in the Z-axis direction due to other members accommodated in the cover 170 as described above. Incidentally, a connecting portion of the flow path member 150 connected to the base member 130 and a connecting portion of the flow path member 150A connected to the base member 130 have a common structure. In addition, a connecting portion of an intermediate member connected to the base member 130 has a common structure with the connecting portions of the flow path members 150 and 150A, and a connecting portion of the intermediate member connected to the flow path member 150 and a connecting portion of the intermediate member connected to the flow path member 150A also have a common structure. As a result, it is possible to easily replace the flow path member 150 and the flow path member 150A or to provide an intermediate member in accordance with the specification of the liquid ejecting head H.

The cover 170 described above has a fixing unit capable of fixing the first member 180 so as not to move with respect to the second member 190 at each of the first position and the second position. In the present embodiment, the fixing unit includes a male screw 200 and a female screw 201, which is formed in the second member 190 and can be screwed with the male screw 200. That is, the first member 180 and the second member 190 are fixed to each other by so-called screw fixing. Specifically, the second peripheral wall portion 191 of the second member 190 is provided with the female screw 201 having a recessed shape that opens to the outer peripheral surface and does not open to the inner peripheral surface. That is, the female screw 201 has a screw hole in which a spiral screw groove is provided along an inner peripheral surface of a recessed portion that opens to the outer peripheral surface of the second peripheral wall portion 191. The female screw 201 described above has a first female screw 201A and a second female screw 201B located further in the −Z direction than is the first female screw 201A. The first female screw 201A and the second female screw 201B are disposed at positions overlapping with each other when viewed in the Z-axis direction. As a result, when the first member 180 moves in the Z-axis direction with respect to the second member 190, a first through-hole 184, which is provided in the first member 180 and into which the male screw 200 is inserted, can be used in common for both the first female screw 201A and the second female screw 201B. Therefore, it is possible to suppress providing of a through-hole, which is not closed by the male screw 200, in the first member 180 when a plurality of through-holes is provided, and to suppress entry of ink to the inside of the cover 170 from the through-hole which is not closed by the male screw 200. Hereinafter, the first female screw 201A and the second female screw 201B are referred to as the female screw 201 when not distinguished from each other. Incidentally, a set of the first female screw 201A and the second female screw 201B is provided at each of both end portions of the cover 170 in the X-axis direction, that is, two sets in total are provided. Needless to say, the number of sets of the first female screw 201A and the second female screw 201B is not particularly limited and may be one set or three or more sets.

The first through-hole 184 passes through the first peripheral wall portion 181 in a thickness direction. One first through-hole 184 is provided at each of both end portions of the first member 180 in the X-axis direction, that is, two first through-holes 184 in total are provided.

Then, as illustrated in FIG. 7, the male screw 200 inserted through the first through-hole 184 of the first member 180 is screwed into the first female screw 201A, whereby the first member 180 and the second member 190 are positioned and fixed at the first position. At this time, the male screw 200 is not screwed into the second female screw 201B.

As illustrated in FIG. 6, the male screw 200 inserted through the same first through-hole 184 is screwed into the second female screw 201B, whereby the first member 180 and the second member 190 are positioned and fixed at the second position. At this time, the male screw 200 is not screwed into the first female screw 201A. Therefore, the first female screw 201A is not covered by the first member 180 and is exposed to the outside. However, since the first female screw 201A has a recessed shape that does not pass through the second peripheral wall portion 191 in the thickness direction, even when the screw hole of the first female screw 201A is exposed to the outside, it is possible to suppress the entry of ink adhering to the inside of the cover 170 or mist-like ink to the inside of the cover 170 through the first female screw 201A.

The fixing unit using the male screw 200 and the female screw 201 described above can release the fixed state between the first member 180 and the second member 190 by releasing the screwing between the male screw 200 and the female screw 201. Therefore, the male screw 200 and the female screw 201 of the present embodiment also function as a “releasing unit”.

As described above, by making the cover 170 expandable and contractible in the Z-axis direction, the cover 170 can be expanded and contracted in the Z-axis direction in accordance with the specification of the liquid ejecting head H, that is, in accordance with the configuration change, the arrangement, or the like of the built-in components accommodated in the cover 170 and can be shared. That is, it is not necessary to prepare a plurality of types of covers having different dimensions in the Z-axis direction in accordance with the specifications of the built-in components accommodated in the cover 170. For this reason, even when the specification of the liquid ejecting head H is changed not only at the time of factory shipment but also at a customer site to which the liquid ejecting head H is provided, it is not necessary to store a plurality of covers having different dimensions in the Z-axis direction on the customer side, and it is not necessary to supply a plurality of covers having different dimensions in the Z-axis direction to the customer, and thus it is possible to reduce the environmental load.

The first member 180 of the cover 170 has an electrical connection opening 185 passing through the bottom wall portion 182 in the Z-axis direction. The external connector 164 of the relay substrate 160 accommodated inside the cover 170 is led out to the outside of the surface facing in the −Z direction through the electrical connection opening 185.

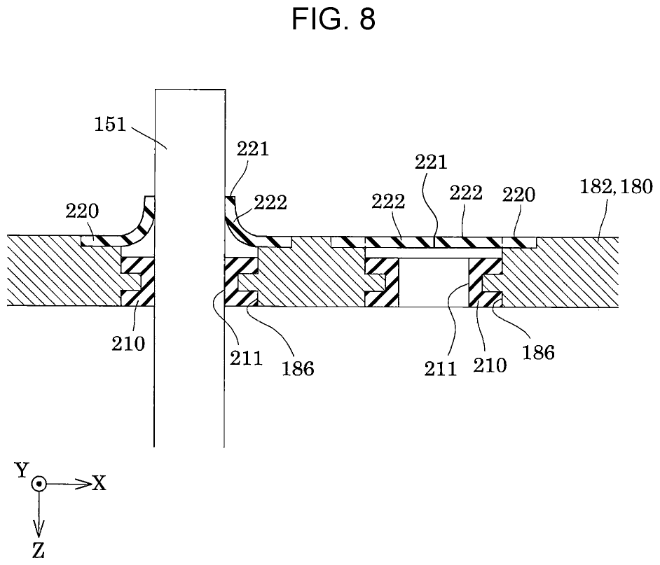

In addition, the first member 180 has four flow path connection openings 186 passing through the bottom wall portion 182 in the Z-axis direction. The flow path connection portions 151 of the flow path member 150 accommodated inside the cover 170 are inserted into the flow path connection openings 186, and leading ends thereof are guided to the outside of the surface facing the −Z direction. In addition, as illustrated in FIG. 8, a first seal member 210 and a second seal member 220 are provided in each flow path connection opening 186. The first seal member 210 and the second seal member 220 are formed of an elastic material such as elastomer.

The second seal member 220 is disposed in the −Z direction with respect to the first seal member 210 in the flow path connection opening 186. That is, the second seal member 220 is disposed closer to the outer surface of the cover 170 than is the first seal member 210 in the Z-axis direction.

The first seal member 210 has an annular shape in which a flow path connection portion insertion hole 211 passing through the first seal member 210 in the Z-axis direction is provided. The flow path connection portion insertion hole 211 has an inner diameter slightly smaller than the outer diameter of each flow path connection portion 151. In an insertion state where the flow path connection portion 151 is inserted into the flow path connection opening 186, the flow path connection portion 151 is inserted into the flow path connection portion insertion hole 211 of the first seal member 210 and closes a gap between the outer peripheral surface of the flow path connection portion 151 and the inner peripheral surface of the flow path connection opening 186. In addition, in a non-insertion state where the flow path connection portion 151 is not inserted into the flow path connection opening 186, the flow path connection portion insertion hole 211 remains open, and thus the first seal member 210 does not close the flow path connection opening 186.

The second seal member 220 has a disk shape provided with a plurality of slit portions 221 passing through the second seal member 220 in the Z-axis direction. The plurality of slit portions 221 is provided radially from the center of the second seal member 220 when viewed in the Z-axis direction. That is, in the second seal member 220, a plurality of triangular protrusions 222 is defined in a circumferential direction from a peripheral edge portion toward the center when viewed in the Z-axis direction by the plurality of slit portions 221. The second seal member 220 closes the flow path connection opening 186 in the non-insertion state where the flow path connection portion 151 is not inserted into the flow path connection opening 186. That is, in the non-insertion state, the plurality of protrusions 222 is in contact with each other and thus does not open the slit portions 221. In addition, in the insertion state where the flow path connection portion 151 is inserted into the flow path connection opening 186, the protrusions 222 are elastically deformed so as to widen the slit portions 221, and thus the flow path connection portion 151 is inserted into the second seal member 220.

By providing the first seal member 210 in this manner, it is possible to suppress the entry of ink to the inside of the cover 170 even when the ink drips at the time of connection, disconnection, or the like between the flow path connection portion 151 and the tube in the insertion state where the flow path connection portion 151 is inserted into the flow path connection opening 186. Therefore, the first seal member 210 can suppress short-circuiting of wiring, failure of mounted electronic components, and the like due to the ink, which has entered the cover 170, adhering to the relay substrate 160 and the like.

In addition, by providing the second seal member 220, as illustrated in FIG. 8, even in the non-insertion state where the flow path connection portion 151 is not inserted into the flow path connection opening 186, since the second seal member 220 closes the flow path connection opening 186, it is possible to suppress the entry of ink dripping at the time of connection and disconnection between the flow path connection portion 151 and the tube and mist-like ink generated at the time of discharge of the ink from the nozzles N to the inside of the cover 170. Therefore, one cover 170 can be used for the flow path members 150 and 150A in which the number of flow path connection portions 151 is different.

In addition, since the second seal member 220 is disposed closer to the outer surface of the cover 170 than is the first seal member 210 in the Z-axis direction, it is possible to suppress the entry of ink to the inside of the first seal member 210 in the non-insertion state, and it is possible to suppress the entry of ink adhering to the first seal member 210 to the inside of the cover 170 in the insertion state.

In the present embodiment, both the first seal member 210 and the second seal member 220 are provided in each flow path connection opening 186, but only one of the first seal member 210 and the second seal member 220 may be provided.

In the present embodiment, as illustrated in FIGS. 7 and 8, the flow path connection opening 186 into which the flow path connection portion 151 is inserted is an example of a “first opening”, and the flow path connection opening 186 into which the flow path connection portion 151 is not inserted is an example of a “second opening”. That is, the liquid ejecting head H illustrated in FIGS. 7 and 8 includes the first opening and the second opening at the same time.

In the present embodiment, two female screws 201, that is, the first female screw 201A and the second female screw 201B are provided, the position of the first member 180 in a state where the male screw 200 is screwed into the first female screw 201A is the first position, and the position of the first member 180 in a state where the male screw 200 is screwed into the second female screw 201B is the second position, but the present disclosure is not particularly limited thereto. For example, three female screws 201 at different positions in the Z-axis direction may be provided as the female screws 201. For example, a third female screw located further in the −Z direction than is the second female screw 201B may be provided. The position of the first member 180 with respect to the second member 190 when the third female screw and the male screw 200 are screwed is referred to as a third position. That is, in the cover 170, the first member 180 and the second member 190 can be fixed to each other by screwing the male screw 200 and the third female screw at the third position. The dimension of the cover 170 in the Z-axis direction when the first member 180 is located at the third position is larger than the dimension L2 of the cover 170 in the Z-axis direction when the first member 180 is located at the second position. In this manner, since the cover 170 can expand and contract in three stages in the Z-axis direction, the cover 170 can correspond to various specification changes of the liquid ejecting head H. The number of stages, in which the cover 170 can expand and contract in the Z-axis direction and can be fixed, is not limited to three and may be four or more.

In addition, in the present embodiment, the first member 180 and the second member 190 are disposed such that the first member 180 is disposed on the outer side, and the second member 190 is disposed on the inner side, but the present disclosure is not particularly limited thereto, and the first member 180 may be disposed on the inner side, and the second member 190 may be disposed on the outer side. In this case, the first through-hole 184 is formed in the second peripheral wall portion 191 of the second member 190, and the female screw 201 is formed in the first peripheral wall portion 181 of the first member 180. However, when the first member 180 is disposed inside the second member 190, a gap between the first peripheral wall portion 181 of the first member 180 and the second peripheral wall portion 191 of the second member 190 opens in the −Z direction. Ink leaking out when the flow path connection portion 151 and the tube are attached and detached easily adheres to the surface facing in the −Z direction of the bottom wall portion 182 of the first member 180, and the ink adhering to the bottom wall portion 182 of the first member 180 easily enters the inside of the cover 170 from the gap between the first member 180 and the second member 190 along the outer peripheral surface of the first peripheral wall portion 181. By disposing the first member 180 outside the second member 190 as in the present embodiment, the gap between the first peripheral wall portion 181 and the second peripheral wall portion 191 opens in the +Z direction. Therefore, even when the ink adhering to the bottom wall portion 182 drips down along the outer peripheral surface of the first peripheral wall portion 181, the ink is unlikely to enter the inside of the cover 170 from the gap. Needless to say, such an operation and effect are effective when the liquid ejecting head H is disposed such that the +Z direction is the downward direction of gravity.

### Second Embodiment

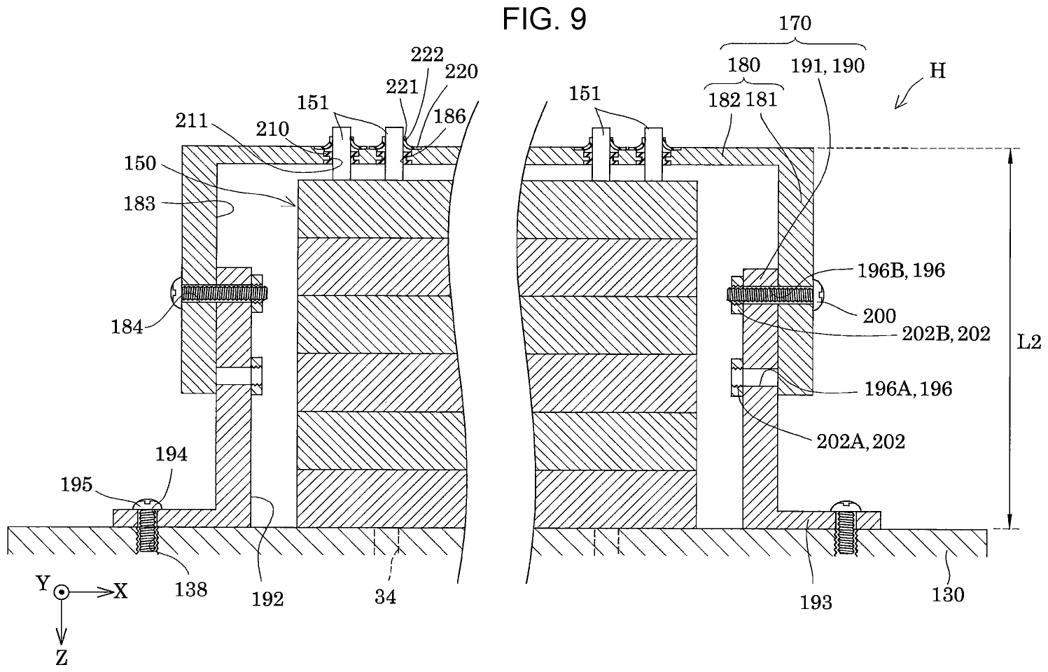

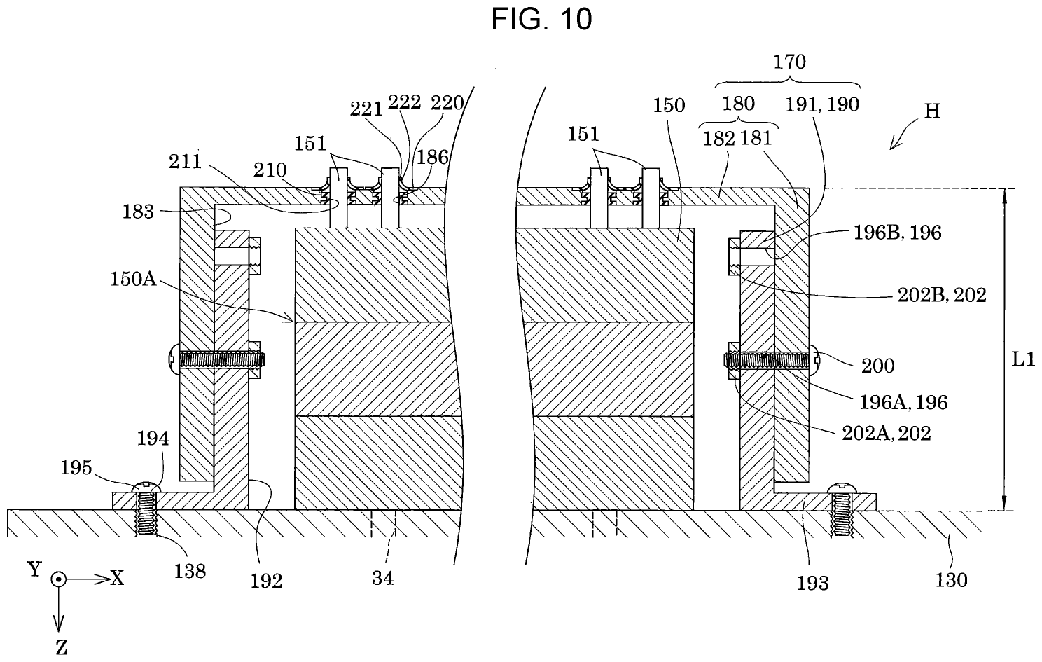

FIG. 9 is a sectional view of a main portion of the liquid ejecting head H according to a second embodiment of the present disclosure and is a diagram illustrating the second position. FIG. 10 is a sectional view of a main portion of the liquid ejecting head H according to the second embodiment and is a diagram illustrating the first position. The same reference numerals are used for the same members as those in the above-described embodiment, and redundant description will be omitted.

As illustrated in FIGS. 9 and 10, the liquid ejecting head H of the present embodiment includes the plurality of head chips Hc provided with the nozzles N that discharge ink droplets, the base member 130, the fixing plate 140, the flow path member 150, the relay substrate 160, and the cover 170, similarly to the first embodiment described above.

The cover 170 of the present embodiment includes the first member 180 and the second member 190. In addition, the cover 170 of the present embodiment is the same as that of the above-described first embodiment except that the fixing unit for fixing the first member 180 and the second member 190 is different from that of the first embodiment, and thus redundant description will be omitted.

In the present embodiment, the fixing unit for fixing the first member 180 and the second member 190 includes the male screw 200 and a nut 202 which is fixed to the second member 190 and into which the male screw 200 is screwed.

The first member 180 has the first through-hole 184 that passes through the first peripheral wall portion 181 in the thickness direction, similarly to the first embodiment described above. One first through-hole 184 is provided at each of both end portions of the first member 180 in the X-axis direction, that is, two first through-holes 184 in total are provided.

The second member 190 includes a second through-hole 196 that passes through the second peripheral wall portion 191 in the thickness direction. Two second through-holes 196 are provided at positions overlapping with each other when viewed in the Z-axis direction. The second through-hole 196 located in the +Z direction is referred to as a second through-hole 196A, and the second through-hole 196 located in the −Z direction is referred to as a second through-hole 196B. The second through-hole 196 described above has an inner diameter slightly larger than that of the male screw 200.

In addition, nuts 202 are fixed to the inner peripheral surface of the second peripheral wall portion 191 at positions corresponding to the second through-holes 196. Each nut 202 is a female screw having a screw hole in which a screw groove is formed. The method of fixing the nut 202 and the second peripheral wall portion 191 is not particularly limited, and for example, adhesion using an adhesive, welding using heat or ultrasonic waves, or the like may be used. In the present embodiment, the nut 202 corresponding to the second through-hole 196A is referred to as a first nut 202A, and the nut 202 corresponding to the second through-hole 196B is referred to as a second nut 202B. A set of two second through-holes 196 and two nuts 202 is provided at each of both end portions of the cover 170 in the X-axis direction, that is, two sets in total are provided.

Then, as illustrated in FIG. 10, the male screw 200 inserted through the first through-hole 184 of the first member 180 is inserted through the second through-hole 196A of the second member 190 and screwed into the first nut 202A, whereby the first member 180 and the second member 190 are positioned and fixed at the first position. At this time, the male screw 200 is not inserted into the second through-hole 196B.

In addition, as illustrated in FIG. 9, the male screw 200 inserted through the same first through-hole 184 is inserted through the second through-hole 196B of the second member 190 and screwed into the second nut 202B, whereby the first member 180 and the second member 190 are positioned and fixed at the second position. At this time, the male screw 200 is not screwed into the second through-hole 196A. At the second position, the second through-hole 196A is disposed at a position covered by the first peripheral wall portion 181. As a result, when the first member 180 is fixed to the second member 190 at the second position, the screw hole of the first nut 202A and the second through-hole 196A are not exposed to the outside, and thus it is possible to suppress the entry of ink adhering to the outside of the cover 170 or mist-like ink to the inside of the cover 170 through the second through-hole 196A.

In the present embodiment, the nuts 202 are provided, but the present disclosure is not particularly limited thereto. Instead of each nut 202, a spiral screw groove may be provided in the inner peripheral surface of the second through-hole 196, and the second through-hole 196 of the second peripheral wall portion 191 may be a screw hole of a female screw. That is, the second through-hole 196A may correspond to a “first female screw”, and the second through-hole 196B may correspond to a “second female screw”. In addition, the second through-hole 196A is an example of a “second through-hole A”, and the second through-hole 196B is an example of a “second through-hole B”. However, in the present embodiment, when the nut 202 is provided, even if the male screw 200 and the nut 202 are repeatedly attached and detached, the screw groove of the nut 202 is less likely to be crushed, and the durability can be improved.

In addition, in the present embodiment, the nuts 202A and 202B are provided corresponding to the second through-holes 196A and 196B, respectively, and are fixed to the inner peripheral surface of the second member 190, but the present disclosure is not limited thereto. By making the nut 202 attachable and detachable instead of being fixed to the second member 190, one nut 202 may be used for each of the second through-holes 196A and 196B. That is, when the nut 202 is disposed at a position corresponding to the second through-hole 196A on the inner peripheral surface of the second peripheral wall portion 191, the male screw 200 can be screwed into the nut 202 by being inserted into the second through-hole 196A, and the first member 180 can be fixed to the second member 190 at the first position. When the nut 202 is disposed at a position corresponding to the second through-hole 196B on the inner peripheral surface of the second peripheral wall portion 191, the male screw 200 can be screwed into the nut 202 by being inserted into the second through-hole 196B, and the first member 180 can be fixed to the second member 190 at the second position. In this case, the second through-hole 196A is an example of the “second through-hole A”, and the second through-hole 196B is an example of the “second through-hole B”.

In the present embodiment, when the second member 190 is disposed outside the first member 180, the first through-hole 184 is formed in the second member 190, and the second through-hole 196 is formed in the first member 180.

### Third Embodiment

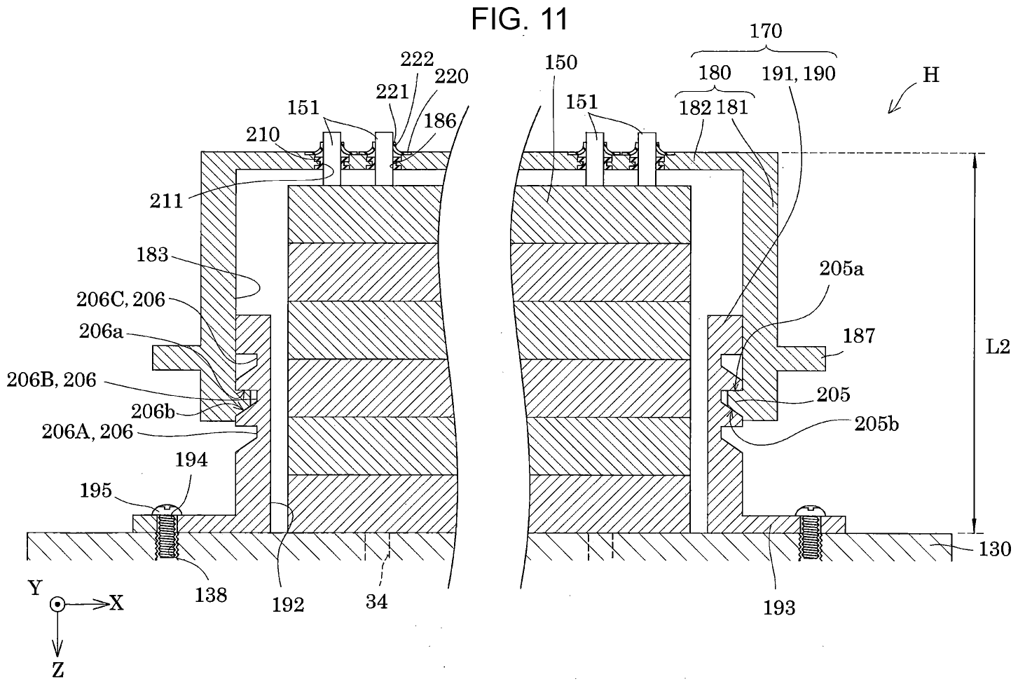

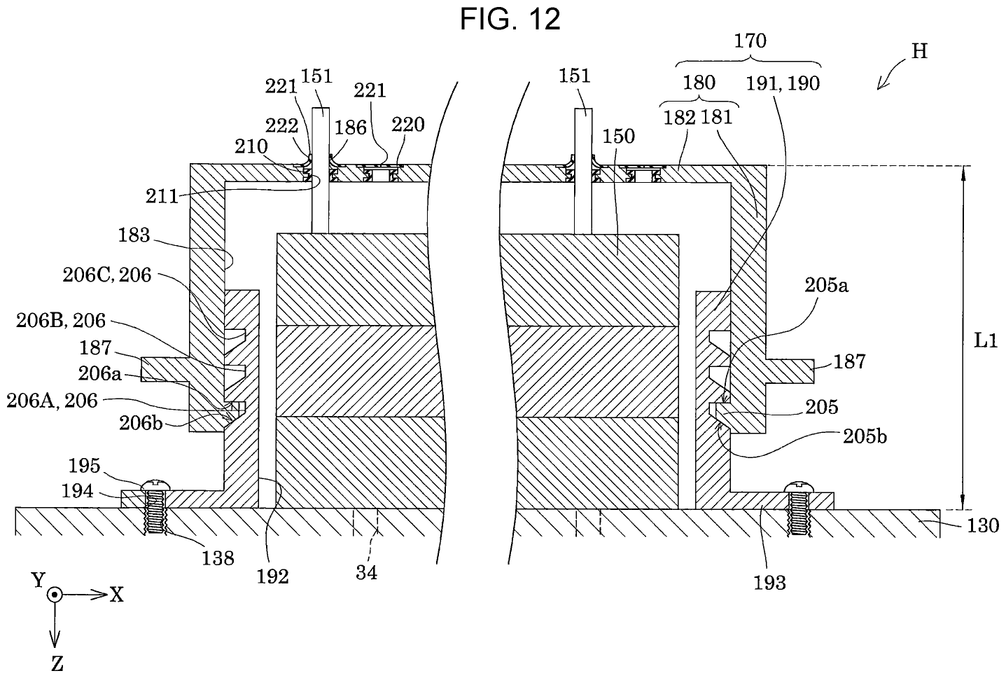

FIG. 11 is a sectional view of a main portion of the liquid ejecting head H according to a third embodiment of the present disclosure and is a diagram illustrating the second position. FIG. 12 is a sectional view of a main portion of the liquid ejecting head H according to the third embodiment and is a diagram illustrating the first position. The same reference numerals are used for the same members as those in the above-described embodiment, and redundant description will be omitted.

As illustrated in FIGS. 11 and 12, the liquid ejecting head H of the present embodiment includes the plurality of head chips Hc provided with the nozzles N that discharge ink droplets, the base member 130, the fixing plate 140, the flow path member 150, the relay substrate 160, and the cover 170, similarly to the first embodiment described above.

The cover 170 of the present embodiment includes the first member 180 and the second member 190. In addition, the cover 170 of the present embodiment is the same as that of the above-described first embodiment except that the fixing unit for fixing the first member 180 and the second member 190 is different from those of the first and the second embodiments, and thus redundant description will be omitted.

In the present embodiment, the fixing unit for fixing the first member 180 and the second member 190 includes a hook 205 provided in the first member 180 and an engagement recessed portion 206 provided in the second member 190.

The hook 205 is provided at an end portion of the first peripheral wall portion 181 in the +Z direction so as to protrude inward from the inner peripheral surface of the recessed portion 183. The surface of the hook 205 facing in the −Z direction is an engaging surface 205a along the XY plane defined by the X-axis and the Y-axis, and the surface of the hook 205 facing in the +Z direction is an inclined surface 205b inclined such that the thickness gradually decreases in the +Z direction.

The engagement recessed portion 206 has a recessed shape that opens to the outer peripheral surface of the second peripheral wall portion 191 of the second member 190. The inner surface located in the −Z direction of the engagement recessed portion 206 is an engaged surface 206a along the XY plane, and the inner surface located in the +Z direction of the engagement recessed portion 206 is an engaged inclined surface 206b inclined such that the depth of the engagement recessed portion 206 gradually increases in the +Z direction.

Three engagement recessed portions 206 described above are provided at different positions in the Z-axis direction. In the present embodiment, the three engagement recessed portions 206 are referred to as a first engagement recessed portion 206A, a second engagement recessed portion 206B, and a third engagement recessed portion 206C in order in the −Z direction. The first engagement recessed portion 206A, the second engagement recessed portion 206B, and the third engagement recessed portion 206C are arranged at positions overlapping with each other when viewed in the Z-axis direction. In addition, a set of the three engagement recessed portions 206 is provided at each of both end portions of the second member 190 in the X-axis direction.

When the engaging surface 205a of the hook 205 is caught by the engaged surface 206a of a corresponding one of the engagement recessed portions 206, the movement of the first member 180 in the −Z direction with respect to the second member 190 is restricted. In addition, when the inclined surface 205b of the hook 205 comes into contact with the engaged inclined surface 206b of the engagement recessed portion 206, the movement of the first member 180 in the +Z direction with respect to the second member 190 is restricted. In addition, since the inclined surface 205b and the engaged inclined surface 206b are inclined surfaces inclined with respect to the XY plane, by pushing the first member 180 in the +Z direction with respect to the second member 190, the inclined surface 205b and the engaged inclined surface 206b are brought into sliding contact with each other, and the hook 205 can be moved to the outside of the second peripheral wall portion 191. Therefore, only by pushing the first member 180 in the +Z direction from a state where the hook 205 is engaged with the third engagement recessed portion 2060, the hook 205 can be moved to a position at which the hook 205 is engaged with the second engagement recessed portion 206B and can be moved to a position at which the hook 205 is engaged with the first engagement recessed portion 206A.

In addition, knob portions 187, which protrude to the outside and can be gripped, are each provided on outer peripheral surfaces on both sides in the X-axis direction of the first peripheral wall portions 181 of the first member 180. By providing the knob portions 187 on both sides in the X-axis direction, the first peripheral wall portions 181 on both sides in the X-axis direction can be easily elastically deformed in a direction away from each other. In this manner, by elastically deforming the first peripheral wall portions 181 on both sides in the X-axis direction in the direction away from each other using the knob portions 187, the engaging surface 205a of the hook 205 is disengaged from the engaged surface 206a of the engagement recessed portion 206, and the first member 180 can be moved in the −Z direction. That is, in the present embodiment, each knob portion 187 is an example of a “releasing unit”.

As described above, the fixing unit of the present embodiment is constituted by snap-fitting for positioning and fixing the first member 180 and the second member 190 by the engagement between the hook 205 and the engagement recessed portion 206.

In the present embodiment, as illustrated in FIG. 12, the position of the first member 180 with respect to the second member 190 in a state where the hook 205 is engaged with the first engagement recessed portion 206A is referred to as the first position. In addition, as illustrated in FIG. 11, the position of the first member 180 with respect to the second member 190 in a state where the hook 205 is engaged with the second engagement recessed portion 206B is referred to as the second position. In addition, although not particularly illustrated, the position of the first member 180 with respect to the second member 190 in a state where the hook 205 is engaged with the third engagement recessed portion 206C is referred to as the third position. The dimension of the cover 170 in the Z-axis direction at the third position is larger than the dimension L2 of the cover 170 in the Z-axis direction at the second position, and the dimension L2 of the cover 170 in the Z-axis direction at the second position is larger than the dimension L1 of the cover 170 in the Z-axis direction at the first position.

In the present embodiment, the three engagement recessed portions 206 are provided for one hook 205, but the number of the engagement recessed portions 206 may be two, or four or more.

In addition, in the present embodiment, the hook 205 of the first member 180 is provided, and each engagement recessed portion 206 is provided in the second member 190, but the present disclosure is not particularly limited thereto, and an engagement recessed portion may be provided in the first member 180, and the hook 205 may be provided in the second member 190.

In the present embodiment, the hook 205 is an example of a “first engaging portion”, the first engagement recessed portion 206A is an example of a “first engaged portion”, and the second engagement recessed portion 206B is an example of a “second engaged portion”.

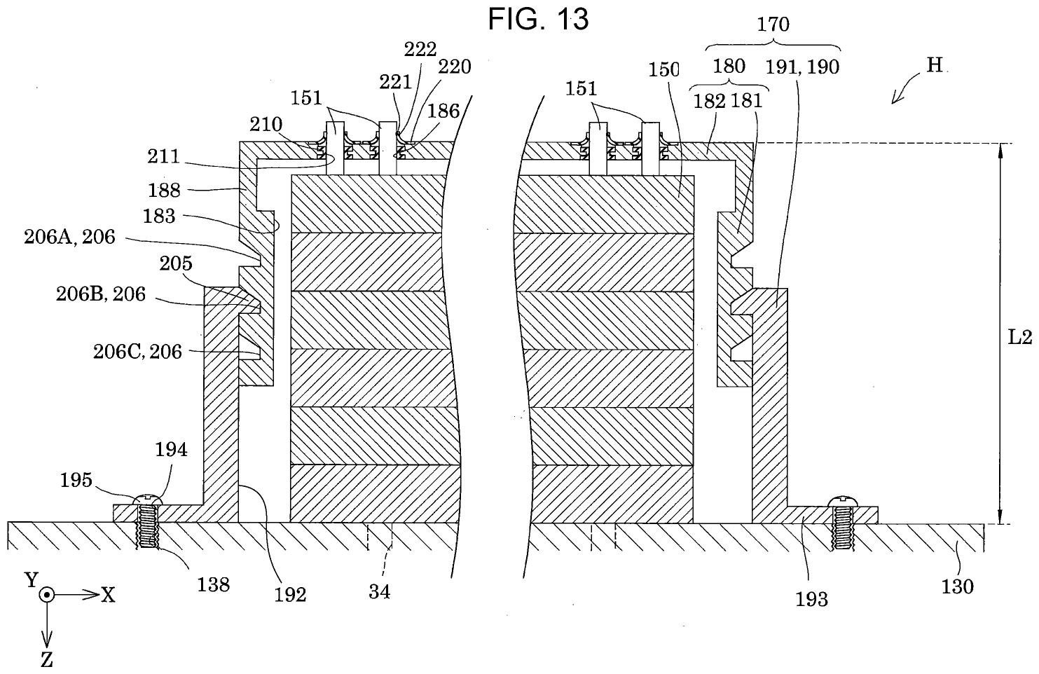

In the present embodiment, a configuration in which the second member 190 is disposed inside the first member 180 has been exemplified, but the present disclosure is not particularly limited thereto, and the first member 180 may be disposed inside the second member 190. FIG. 13 illustrates a modification of the liquid ejecting head H according to the third embodiment described above. FIG. 13 is a sectional view of a main portion illustrating the modification of the liquid ejecting head H according to the third embodiment and is a diagram illustrating the second position.

As illustrated in FIG. 13, the first through portion 192 of the second member 190 is slightly larger than each first peripheral wall portion 181 of the first member 180, and the first member 180 is inserted into the first through portion 192.

In addition, the hook 205 is provided inside an end portion of the second peripheral wall portion 191 in the −Z direction. Moreover, the engagement recessed portion 206 is provided in the outer peripheral surface of the first peripheral wall portion 181. Three engagement recessed portions 206 are provided at different positions in the Z-axis direction.

In addition, an end portion of the first peripheral wall portion 181 in the −Z direction is a thin portion 188 that is thinner than other regions. By providing the thin portion 188 in this manner, the first peripheral wall portions 181 on both sides of the first member 180 in the X-axis direction can be easily deformed in a direction approaching each other when the engagement state between the hook 205 and a corresponding one of the engagement recessed portions 206 is released. That is, in the example illustrated in FIG. 13, the thin portion 188 is an example of the “releasing unit”.

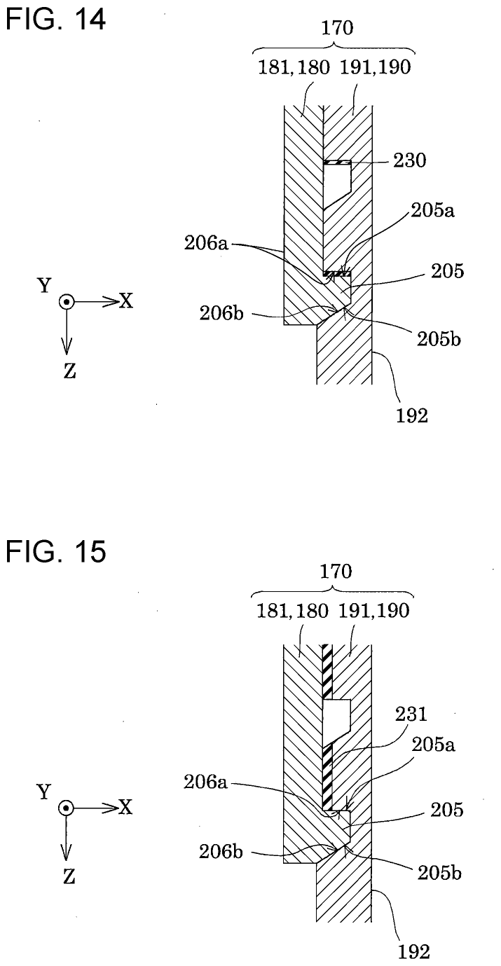

In the present embodiment, a seal member may be provided between the hook 205 and the engagement recessed portion 206. Such an example is illustrated in FIGS. 14 and 15. FIGS. 14 and 15 are enlarged sectional views of a main portion illustrating the modification of the liquid ejecting head H according to the present embodiment. As illustrated in FIG. 14, a seal member 230 formed of an elastic material such as rubber is provided on a surface on which the hook 205 and the engagement recessed portion 206 face each other in the Z-axis direction, that is, on one or both of the engaging surface 205a and the engaged surface 206a. In the present embodiment, the seal member 230 is provided on the engaged surface 206a of the engagement recessed portion 206. As a result, the gap between the engaging surface 205a and the engaged surface 206a can be sealed by the seal member 230, and it is possible to suppress the entry of ink to the inside of the cover 170 from the gap.

In addition, as illustrated in FIG. 15, a seal member 231 may be provided on at least one of the surfaces of the first peripheral wall portion 181 and the second peripheral wall portion 191 facing each other in a direction orthogonal to the Z-axis direction. In the present embodiment, the seal member 231 is provided on the outer peripheral surface of the second peripheral wall portion 191. As a result, the gap between the first peripheral wall portion 181 and the second peripheral wall portion 191 can be sealed by the seal member 231, and it is possible to suppress the entry of ink to the inside of the cover 170 from the gap. Needless to say, both the seal members 230 and 231 may be provided. In this manner, by providing the seal members 230 and 231, it is possible to suppress the entry of ink to the inside of the cover 170 from a gap between the first member 180 and the second member 190.

### Other Embodiments

Although each embodiment of the present disclosure has been described above, the basic configuration of the present disclosure is not limited to the above-described embodiments.

For example, in the above-described first and second embodiments, a seal member made of an elastic material may be provided to suppress the entry of ink from a gap between the first member 180 and the second member 190.

In addition, in the first and second embodiments described above, the female screw 201 or the nut 202 is provided in the second member 190, but the present disclosure is not particularly limited thereto. For example, the first member 180 and the second member 190 may be fixed by providing a spiral screw groove in the inner peripheral surface of the first through-hole 184 provided in the first peripheral wall portion 181 of the first member 180 to make the first through-hole 184 a female screw and pressing the leading end of the male screw 200 screwed into the first through-hole 184 against the outer peripheral surface of the second peripheral wall portion 191 of the second member 190. With such a configuration, the first member 180 can be positioned at an appropriate position in the Z-axis direction with respect to the second member 190, and since the second through-hole 196 is not provided in the second member 190, it is possible to suppress the entry of ink to the inside of the cover 170 through the second through-hole 196.

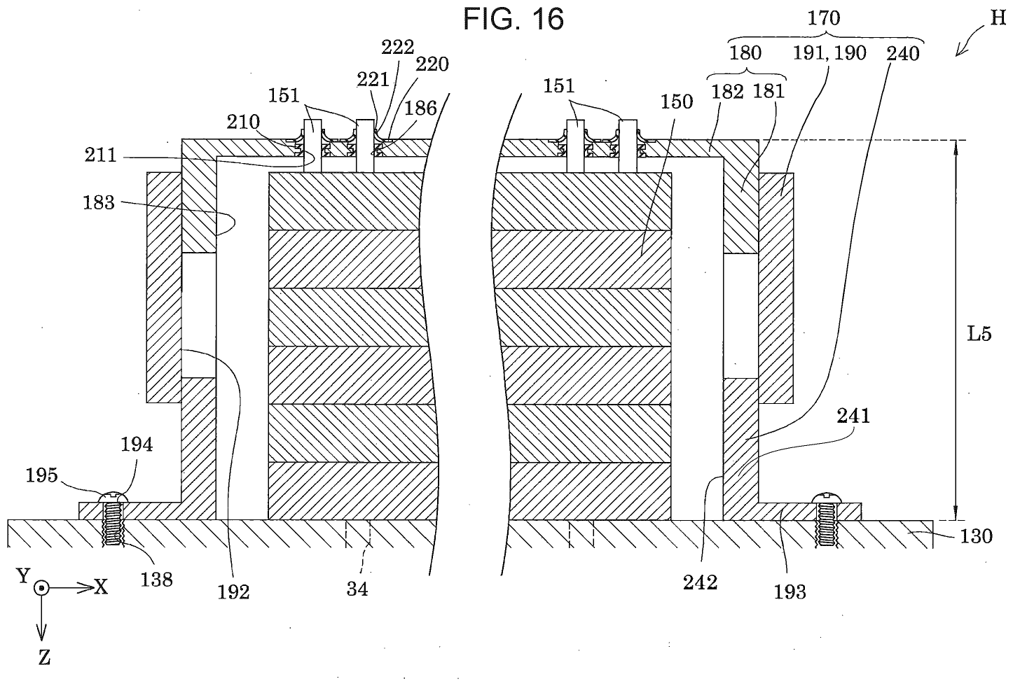

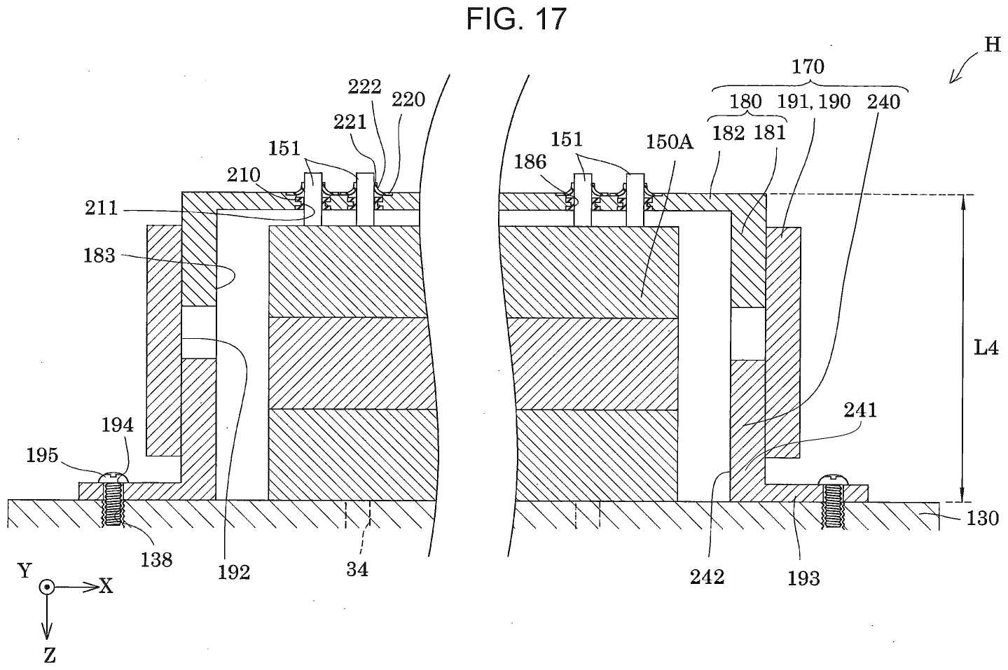

In addition, in each of the above-described embodiments, the cover 170 is constituted by two members of the first member 180 and the second member 190, but the present disclosure is not particularly limited thereto, and the cover 170 may be constituted by three or more members. Here, FIGS. 16 and 17 illustrate an example in which the cover 170 is constituted by three members. FIG. 16 is a sectional view of a main portion illustrating the liquid ejecting head H according to another embodiment and is a view illustrating a fifth position. In addition, FIG. 17 is a sectional view of a main portion illustrating the liquid ejecting head H according to another embodiment and is a view illustrating a fourth position. In addition, in FIGS. 16 and 17, the fixing unit is omitted.

As illustrated in FIGS. 16 and 17, the cover 170 includes the first member 180, the second member 190, and a third member 240.

The first member 180 is disposed farthest in the −Z direction and includes the first peripheral wall portion 181 and the bottom wall portion 182, similarly to each of the embodiments described above.

The second member 190 is disposed further in the +Z direction than is the first member 180 and includes the second peripheral wall portion 191, similarly to each of the embodiments described above. In the present embodiment, the second member 190 is not provided with a flange portion. The first peripheral wall portion 181 of the first member 180 is inserted into a through-hole of the second member 190, whereby the first member 180 is movable to the first position and the second position with respect to the second member 190.

The third member 240 is disposed further in the +Z direction than is the second member 190. The third member 240 includes a third peripheral wall portion 241 having an annular shape when viewed in the Z-axis direction and the flange portion 193. In the third member 240, a second through portion 242 extending in the Z-axis direction is defined by the third peripheral wall portion 241. By inserting the third peripheral wall portion 241 of the third member 240 into the first through portion 192 of the second peripheral wall portion 191 of the second member 190, the second member 190 is movable in the Z-axis direction with respect to the third member 240. The flange portion 193 has the same configuration as the flange portion 193 provided in the second member 190 of each of the embodiments described above.

Here, the second member 190 is movable between the fourth position illustrated in FIG. 17 and the fifth position illustrated in FIG. 16 by moving in the Z-axis direction with respect to the third member 240. Here, a dimension L5 of the cover 170 in the Z-axis direction when the second member 190 is located at the fifth position is larger than a dimension L4 of the cover 170 in the Z-axis direction when the second member 190 is located at the fourth position. That is, a relationship of L5>L4 is satisfied. The dimensions L4 and L5 of the cover 170 located at the fourth position and the fifth position are compared when the position of the first member 180 with respect to the second member 190 is the same. That is, since the dimension of the cover 170 in the Z-axis direction is different between the case where the position of the first member 180 with respect to the second member 190 is the first position and the case where the position is the second position, when the fourth position and the fifth position are compared, if the first position and the second position are mixed, the comparison cannot be accurately performed.

Although the fixing unit for fixing the first member 180 and the second member 190 is not illustrated in FIGS. 16 and 17, any of the fixing units of the embodiments described above may be used. The same applies to the fixing unit for fixing the second member 190 and the third member 240.

By constituting the cover 170 with three members in this manner, the dimension of the cover 170 in the Z-axis direction can be further increased, and the dimension of the cover 170 in the Z-axis direction can be changed in multiple stages. Therefore, the cover 170 illustrated in FIGS. 16 and 17 can correspond to a larger number of different specifications of the liquid ejecting head H.

In addition, in each of the above-described embodiments and FIGS. 16 and 17, the cover 170 is formed of two members of the first member 180 and the second member 190 or three members of the first member 180, the second member 190, and the third member 240, but the present disclosure is not particularly limited thereto. For example, the cover 170 may be formed of only the first member 180, and a part of the first peripheral wall portion 181 may have a bellows shape extending in the Z-axis direction. Even in the cover 170 described above, since the dimension in the Z-axis direction can be changed according to the change in the height of the built-in components, the cover 170 can be used in common for the liquid ejecting heads H having various specifications.

For the liquid ejecting apparatus 1 described above, an example in which the liquid ejecting head H is mounted in the holding body 6a and moves in a main scanning direction is described, but the present disclosure is not particularly limited thereto. For example, the present disclosure can also be applied to a so-called line printer in which the liquid ejecting head H is fixed and only the medium S is moved in a sub-scanning direction to perform printing.

Moreover, the present disclosure is intended to cover a wide range of liquid ejecting apparatuses including liquid ejecting heads. Examples of the liquid ejecting heads include a recording head such as various ink jet recording heads used in an image recording apparatus such as a printer, and a coloring material ejecting head used for manufacturing a color filter in a liquid crystal display and the like. In addition, examples of the liquid ejecting heads include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses including these liquid ejecting heads.

### Supplementary Notes

From the embodiments described above, for example, the following configurations can be understood.

A liquid ejecting head according to a first aspect, which is a preferred aspect, includes a liquid ejecting unit that ejects a liquid, a flow path member in communication with the liquid ejecting unit, a relay substrate electrically connected to the liquid ejecting unit, and a cover that accommodates at least one of the flow path member and the relay substrate therein and is expandable and contractible in a height direction. According to this aspect, the height dimension of the cover can be changed in accordance with the specification of the liquid ejecting head. Therefore, it is possible to make the cover common to liquid ejecting heads having different specifications. Therefore, even when the specification of the liquid ejecting head is changed not only at the time of factory shipment but also at the customer site, it is not necessary to prepare and store a plurality of types of covers having different height dimensions on the customer side, it is not necessary to provide a new cover to the customer, and it is possible to reduce the environmental load.

In a second aspect, which is a specific example of the first aspect, the cover includes a first member having a recessed shape, and a second member including a second peripheral wall portion having an annular shape when viewed in the height direction, and the first member is movable, in a height direction with respect to the second member, between a first position and a second position at which a height dimension of the cover is larger than the height dimension of the cover when the cover is located at the first position. According to this aspect, the height dimension of the cover can be changed in two stages of the first position and the second position.

In a third aspect, which is a specific example of the second aspect, the cover includes a fixing unit capable of fixing the first member such that the first member does not move with respect to the second member at each of the first position and the second position. According to this aspect, the cover can be positioned at the first position and the second position.

In a fourth aspect, which is a specific example of the third aspect, the first member is movable, in the height direction with respect to the second member, to a third position at which the height dimension of the cover is larger than the height dimension of the cover when the cover is located at the second position, and the fixing unit is capable of fixing the first member such that the first member does not move with respect to the second member at the third position. According to this aspect, since the height dimension of the cover can be changed in three or more stages, the cover can be used for liquid ejecting heads having various specifications.

In a fifth aspect, which is a specific example of the third aspect, the fixing unit includes a first engaging portion provided in one of the first member and the second member, and a first engaged portion and a second engaged portion provided in another one of the first member and the second member, the first member is fixed at the first position and does not move with respect to the second member by engagement between the first engaging portion and the first engaged portion, and the first member is fixed at the second position and does not move with respect to the second member by engagement between the first engaging portion and the second engaged portion. According to this aspect, the first member and the second member can be easily fixed at the first position and the second position.

In a sixth aspect, which is a specific example of the first aspect, the liquid ejecting head further includes a base member that accommodates the liquid ejecting unit, and the cover is detachably fixed to the base member. According to this aspect, it is possible to easily attach and detach the cover to and from the base member and to easily change the specification of the liquid ejecting head.

In a seventh aspect, which is a specific example of the second aspect, the cover includes a third member connected to the first member via the second member and including a third peripheral wall portion having an annular shape when viewed in the height direction, and the second member is movable, in the height direction with respect to the third member, between a fourth position and a fifth position at which the height dimension of the cover is larger than the height dimension of the cover at the fourth position. According to this aspect, the cover can be used for liquid ejecting heads having more various specifications by increasing the variation of the height dimension of the cover.

In an eighth aspect, which is a specific example of the second aspect, the flow path member includes a flow path tube extending in the height direction, the first member includes a bottom wall portion having an opening passing through the bottom wall portion in the height direction, a first seal member disposed inside the opening, and a second seal member disposed inside the opening and disposed at a position different from the first seal member in the height direction, the first seal member closes a gap between an outer peripheral surface of the flow path tube and an inner peripheral surface of the opening in an insertion state where the flow path tube is inserted into the opening, and does not close the opening in a non-insertion state where the flow path tube is not inserted into the opening, and the second seal member opens the opening in the insertion state such that the flow path tube is capable of being inserted into the opening and closes the opening in the non-insertion state. According to this aspect, when the flow path tube is inserted, the first seal member can suppress the entry, to the inside of the cover, of a liquid dripping from the flow path tube or a mist-like liquid generated by being ejected. In addition, at the time of non-insertion, the second seal member can suppress the entry, to the inside of the cover, of a liquid dripping from the flow path tube and adhering to the cover or a mist-like liquid.

In a ninth aspect, which is a specific example of the eighth aspect, the first member includes a first opening that is the opening in the insertion state and a second opening that is the opening in the non-insertion state. The first opening can suppress the entry of a liquid to the inside of the cover by the first seal member, and the second opening can suppress the entry of the liquid to the inside of the cover by the second seal member.

In a tenth aspect, which is a specific example of the eighth aspect, the second seal member is disposed closer to an outer surface of the cover than is the first seal member in the height direction. According to this aspect, it is possible to suppress the entry of a liquid to the inside of the first seal member in the non-insertion state, and it is possible to suppress the entry of the liquid adhering to the first seal member to the inside of the cover in the insertion state.

In an eleventh aspect, which is a specific example of the third aspect, the cover includes a releasing unit for releasing a fixed state of the first member and the second member by the fixing unit. According to this aspect, by providing the releasing unit for releasing the fixed state by the fixing unit, the dimension of the cover in the height direction can be easily changed.

In a twelfth aspect, which is a specific example of the third aspect, the fixing unit includes a male screw, a first female screw capable of fixing the first member to the second member at the first position by being screwed with the male screw, and a second female screw capable of fixing the first member to the second member at the second position by being screwed with the male screw, the first member includes a first peripheral wall portion having an annular shape when viewed in the height direction, the first female screw and the second female screw are formed in one peripheral wall portion, of the first peripheral wall portion and the second peripheral wall portion, located on an inner side, and the first female screw has a recessed shape that opens to an outer peripheral surface of the one peripheral wall portion and does not open to an inner peripheral surface of the one peripheral wall portion. According to this aspect, the first member and the second member can be easily fixed to each other by screw fixing.

In a thirteenth aspect, which is a specific example of the third aspect, the fixing unit includes a male screw, a first nut capable of fixing the first member to the second member at the first position by being screwed with the male screw, and a second nut capable of fixing the first member to the second member at the second position by being screwed with the male screw, the first member includes a first peripheral wall portion having an annular shape when viewed in the height direction, the first nut and the second nut are provided in an inner peripheral surface of one peripheral wall portion, of the first peripheral wall portion and the second peripheral wall portion, located on an inner side, and the first nut has a screw hole covered by another peripheral wall portion, of the first peripheral wall portion and the second peripheral wall portion, located on an outer side in a state where the first member is fixed to the second member at the second position. According to this aspect, the first member and the second member can be easily fixed to each other at the first position and the second position by screw fixing. In addition, since the screw hole of the first nut is covered by the other peripheral wall portion located on the outer side at the second position, it is possible to suppress the entry of a liquid to the inside of the cover via the screw hole.

In a fourteenth aspect, which is a specific example of the third aspect, the fixing unit includes a male screw, a first female screw capable of fixing the first member to the second member at the first position by being screwed with the male screw, and a second female screw capable of fixing the first member to the second member at the second position by being screwed with the male screw, the first member includes a first peripheral wall portion having an annular shape when viewed in the height direction, the first female screw has a screw hole formed in an inner peripheral surface of a second through-hole A formed in one peripheral wall portion, of the first peripheral wall portion and the second peripheral wall portion, located on an inner side, the second female screw has a screw hole formed in an inner peripheral surface of a second through-hole B formed in the one peripheral wall portion, and the second through-hole A is covered by another peripheral wall portion, of the first peripheral wall portion and the second peripheral wall portion, located on an outer side in a state where the first member is fixed to the second member at the second position. According to this aspect, in a state where the first member is fixed to the second member at the second position, the second through-hole A is covered by the other peripheral wall portion located on the outer side, and thus it is possible to suppress the entry of a liquid to the inside of the cover via the screw hole.

In a fifteenth aspect, which is a specific example of the third aspect, the first member includes a first peripheral wall portion having an annular shape when viewed in the height direction, one peripheral wall portion, of the first peripheral wall portion and the second peripheral wall portion, located on an inner side has a second through-hole A and a second through-hole B, the fixing unit includes a male screw, and a nut capable of fixing the first member to the second member at the first position by being screwed with the male screw inserted into the second through-hole A and capable of fixing the first member to the second member at the second position by being screwed with the male screw inserted into the second through-hole B, and the second through-hole A is covered by another peripheral wall portion, of the first peripheral wall portion and the second peripheral wall portion, located on an outer side in a state where the first member is fixed to the second member at the second position. According to this aspect, in a state where the first member is fixed to the second member at the second position, the second through-hole A is covered by the other peripheral wall portion located on the outer side, and thus it is possible to suppress the entry of a liquid to the inside of the cover via the screw hole. Moreover, the number of components of the nut can be reduced so as to reduce the cost.

A liquid ejecting apparatus according to a sixteenth aspect, which is a preferred aspect, includes the liquid ejecting head according to the above-described aspects, and a liquid storage unit that stores a liquid to be supplied to the liquid ejecting head. According to this aspect, the height dimension of the cover can be changed in accordance with the specification of the liquid ejecting head. Therefore, it is possible to make the cover common to liquid ejecting heads having different specifications and to reduce the environmental load.

What is claimed is:

1. A liquid ejecting head comprising:
a liquid ejecting unit configured to eject a liquid;
a flow path member in communication with the liquid ejecting unit;
a relay substrate electrically connected to the liquid ejecting unit; and
a cover that accommodates at least one of the flow path member and the relay substrate therein and is configured to expand and contract in a height direction.

2. The liquid ejecting head according to claim 1, wherein
the cover includes
a first member having a recessed shape, and
a second member including a second peripheral wall portion having an annular shape when viewed in the height direction, and
the first member is configured to move, in a height direction with respect to the second member, between a first position and a second position at which a height dimension of the cover is larger than the height dimension of the cover when the cover is located at the first position.

3. The liquid ejecting head according to claim 2, wherein
the cover includes a fixing unit configured to fix the first member such that the first member does not move with respect to the second member at each of the first position and the second position.

4. The liquid ejecting head according to claim 3, wherein
the first member is configured to move, in the height direction with respect to the second member, to a third position at which the height dimension of the cover is larger than the height dimension of the cover when the cover is located at the second position, and
the fixing unit is configured to fix the first member such that the first member does not move with respect to the second member at the third position.

5. The liquid ejecting head according to claim 3, wherein
the fixing unit includes
a first engaging portion provided in one of the first member and the second member, and
a first engaged portion and a second engaged portion provided in another one of the first member and the second member,
the first member is fixed at the first position and does not move with respect to the second member by engagement between the first engaging portion and the first engaged portion, and
the first member is fixed at the second position and does not to move with respect to the second member by engagement between the first engaging portion and the second engaged portion.

6. The liquid ejecting head according to claim 1, further comprising
a base member that accommodates the liquid ejecting unit, wherein
the cover is detachably fixed to the base member.

7. The liquid ejecting head according to claim 2, wherein
the cover includes a third member connected to the first member via the second member and including a third peripheral wall portion having an annular shape when viewed in the height direction, and
the second member is configured to move, in the height direction with respect to the third member, between a fourth position and a fifth position at which the height dimension of the cover is larger than the height dimension of the cover at the fourth position.

8. The liquid ejecting head according to claim 2, wherein
the flow path member includes a flow path tube extending in the height direction,
the first member includes
a bottom wall portion having an opening passing through the bottom wall portion in the height direction,
a first seal member disposed inside the opening, and
a second seal member disposed inside the opening and disposed at a position different from the first seal member in the height direction,
the first seal member closes a gap between an outer peripheral surface of the flow path tube and an inner peripheral surface of the opening in an insertion state where the flow path tube is inserted into the opening, and does not close the opening in a non-insertion state where the flow path tube is not inserted into the opening, and
the second seal member opens the opening in the insertion state such that the flow path tube is configured to be inserted into the opening and closes the opening in the non-insertion state.

9. The liquid ejecting head according to claim 8, wherein
the first member includes a first opening that is the opening in the insertion state and a second opening that is the opening in the non-insertion state.

10. The liquid ejecting head according to claim 8, wherein
the second seal member is disposed closer to an outer surface of the cover than is the first seal member in the height direction.

11. The liquid ejecting head according to claim 3, wherein
the cover includes a releasing unit for releasing a fixed state of the first member and the second member by the fixing unit.

12. The liquid ejecting head according to claim 3, wherein
the fixing unit includes
a male screw,
a first female screw configured to fix the first member to the second member at the first position by being screwed with the male screw, and
a second female screw configured to fix the first member to the second member at the second position by being screwed with the male screw,
the first member includes a first peripheral wall portion having an annular shape when viewed in the height direction,
the first female screw and the second female screw are formed in one peripheral wall portion, of the first peripheral wall portion and the second peripheral wall portion, located on an inner side, and
the first female screw has a recessed shape that opens to an outer peripheral surface of the one peripheral wall portion and does not open to an inner peripheral surface of the one peripheral wall portion.

13. The liquid ejecting head according to claim 3, wherein
the fixing unit includes
a male screw,
a first nut configured to fix the first member to the second member at the first position by being screwed with the male screw, and
a second nut configured to fix the first member to the second member at the second position by being screwed with the male screw,
the first member includes a first peripheral wall portion having an annular shape when viewed in the height direction,
the first nut and the second nut are provided in an inner peripheral surface of one peripheral wall portion, of the first peripheral wall portion and the second peripheral wall portion, located on an inner side, and
the first nut has a screw hole covered by another peripheral wall portion, of the first peripheral wall portion and the second peripheral wall portion, located on an outer side in a state where the first member is fixed to the second member at the second position.

14. The liquid ejecting head according to claim 3, wherein
the fixing unit includes
a male screw,
a first female screw configured to fix the first member to the second member at the first position by being screwed with the male screw, and
a second female screw configured to fix the first member to the second member at the second position by being screwed with the male screw,
the first member includes a first peripheral wall portion having an annular shape when viewed in the height direction,
the first female screw has a screw hole formed in an inner peripheral surface of a second through-hole A formed in one peripheral wall portion, of the first peripheral wall portion and the second peripheral wall portion, located on an inner side,
the second female screw has a screw hole formed in an inner peripheral surface of a second through-hole B formed in the one peripheral wall portion, and
the second through-hole A is covered by another peripheral wall portion, of the first peripheral wall portion and the second peripheral wall portion, located in an outer side in a state where the first member is fixed to the second member at the second position.

15. The liquid ejecting head according to claim 3, wherein
the first member includes a first peripheral wall portion having an annular shape when viewed in the height direction,
one peripheral wall portion, of the first peripheral wall portion and the second peripheral wall portion, located on an inner side has a second through-hole A and a second through-hole B,
the fixing unit includes
a male screw, and
a nut configured to fix the first member to the second member at the first position by being screwed with the male screw inserted into the second through-hole A and configured to fix the first member to the second member at the second position by being screwed with the male screw inserted into the second through-hole B, and
the second through-hole A is covered by another peripheral wall portion, of the first peripheral wall portion and the second peripheral wall portion, located on an outer side in a state where the first member is fixed to the second member at the second position.

16. A liquid ejecting apparatus comprising:
the liquid ejecting head according to claim 1; and
a liquid storage unit that stores a liquid to be supplied to the liquid ejecting head.
